(19) United States
(12) Patent Application Publication
(10) Pub. No.: US 2018/0354286 A1
(43) Pub. Date: Dec. 13, 2018

(54) A PRINTING METHOD

(71) Applicants: BOE TECHNOLOGY GROUP CO., LTD., Beijing (CN); ORDOS YUANSHENG OPTOELECTRONICS CO., LTD., Ordos, Inner Mongolia (CN)

(72) Inventors: Jingjing CHEN, Beijing (CN); Lina WANGL, Beijing (CN); Liang ZHANG, Beijing (CN); Defu ZHANG, Beijing (CN); Fuyi CUI, Beijing (CN)

(21) Appl. No.: 15/736,730

(22) PCT Filed: Jun. 16, 2017
(86) PCT No.: PCT/CN2017/088679

§ 371 Date: Dec. 14, 2017

(30) Foreign Application Priority Data
Aug. 12, 2016 (CN) 201610664141.2

(51) Int. Cl. B41M 7/00; B41M 1/12

(52) U.S. Cl. CPC B41M 7/009; B41M 1/12

(57) ABSTRACT

Described is a printing method comprising: forming an organic material layer on a non-printing region of a substrate, the burning point of the organic material layer being lower than the pre-curing temperature of glass glue; performing printing processing on the substrate so as to form the glass glue on a printing region of the substrate; and performing a burning processing of the organic material layer so as to separate the organic material layer from the substrate. Such a printing method can effectively avoid the occurrence of the printing offset and burrs and thus greatly reduce the rate of defective goods.

### FIELD OF THE INVENTION

The disclosure relates to the field of display technology, and in particular, to a printing method.

### BACKGROUND OF THE INVENTION

The printing process is an important link of the glass glue encapsulation process, and the quality of the effect of the printing process directly affects the encapsulation effect. Because of the advantages that the device is simple, the operations are convenient, the plate making is easy and cost-effective, and the adaptability is strong, and the like, the screen printing has already become a widely applied printing method. However, since the screen of the screen printing has a certain tension and the material and the production process of the screen cannot ensure that the tensions of individual points are identical, this results in that the offset directions and the offset amounts of the glass glue at different points in the procedure of printing are different, that is, the offset degrees of the printed glass glue at individual positions are different. In addition, since the glass glue has certain liquidity, this results in that the burr phenomenon will occur to a graphic printed by the screen.

The printing offset will affect both the subsequent laser sealing process and cutting process. First, when the printing offset is too large, since the laser route of the laser sealing process is fixed, this results in that the glass cannot be effectively sintered by laser, and then easily leads to encapsulation failure. Second, since the printing offset is too large, this may give rise to a case of the glass covering the cutting line, and thereby easily causes poor cutting. Likewise, too large glass burrs also easily cause poor cutting.

### SUMMARY OF THE INVENTION

With respect to the problems existing in the related art, the disclosure provides a printing method, which may at least partly solve the problems of printing offset and burrs existing in the printing process of the related art.

According to an embodiment of the disclosure, there is provided a printing method comprising: forming an organic material layer on a non-printing region of a substrate, the burning point of the organic material layer being lower than the pre-curing temperature of glass glue; performing printing processing on the substrate so as to form the glass glue on a printing region of the substrate; and performing a burning processing of the organic material layer so as to separate the organic material layer from the substrate.

By forming the organic material layer on the substrate, the printing method according to the disclosure causes the organic material layer to fully block the non-printing region when the glass glue is printed, and then removes or takes away excess glass glue which causes the printing offset and burrs by burning processing, thereby effectively avoiding the occurrence of the printing offset and burrs and greatly reducing the rate of defective goods.

In an embodiment of the printing method according to the disclosure, the step of performing a burning processing of the organic material layer may comprise performing a pre-curing processing of the glass glue. Since the burning point of the organic material layer is lower than the pre-curing temperature of the glass glue, it is ensured that burning processing may certainly be performed on the organic material layer when the pre-curing processing of the glass glue is performed, so that the burning processing of the organic material layer can be done by the pre-curing processing of the glass glue.

In an embodiment of the printing method according to the disclosure, the pre-curing temperature of the glass glue can range from 100° C. to 120° C. At this point, the range of the burning point of the organic material layer may be 85° C. to 115° C. For example, the pre-curing temperature of the glass glue is 100° C., and the range of the burning point of the organic material layer is 85° C. to 95° C.; or, the pre-curing temperature of the glass glue is 120° C., and the range of the burning point of the organic material layer is 105° C. to 115° C.; or, the pre-curing temperature is 110° C., and the range of the burning point is 95° C. to 105° C.; or, the pre-curing temperature is 110° C., and the burning point is 100° C.

In an embodiment of the printing method according to the disclosure, before the step of performing a burning processing of the organic material layer, the printing method may comprise: placing the substrate in flowing gas with a fixed flow direction. Consequently, when the organic material layer is burned, the glass glue adhered to the organic material layer will be driven up and taken away together with hot gas, thereby effectively avoiding the occurrence of the printing offset and burrs so as to greatly reduce the rate of defective goods.

In an embodiment of the printing method according to the disclosure, the flowing gas may be compressed air.

In an embodiment of the printing method according to the disclosure, the organic material layer and the glass glue may have the same thickness, and/or the organic material layer may be made of a material which cannot react chemically with the glass glue 104, thereby avoiding damage to the glass glue and hence to the printing process.

### BRIEF DESCRIPTION OF THE DRAWINGS

FIG. 1 shows a flow chart of a printing method according to an embodiment of the disclosure;

FIG. 2 shows a schematic diagram of the step 1001 of forming an organic material layer on a non-printing region of a substrate of the printing method as shown in FIG. 1;

FIG. 3 shows a schematic diagram of the step 1002 of forming glass glue on a printing region of the substrate of the printing method as shown in FIG. 1;

FIG. 4 shows a sectional view illustrating the occurrence of printing offset to the glass glue in the procedure of performing printing processing on the substrate in the printing method as shown in FIG. 1;

FIG. 5 shows a sectional view of the glass glue to which the printing offset occurs as shown in FIG. 4 after leveling; and

FIG. 6 shows a separation diagram of the glass glue with printing offset and the glass glue for which the printing is normal in the procedure of burning processing of the organic material layer in the printing method as shown in FIG. 1.

### DETAILED DESCRIPTION OF THE INVENTION

To make the skilled in the art better understand the technical solutions of the disclosure, in the following, the technical solutions of the disclosure will be described in detail in conjunction with the drawings.

FIG. 1 schematically shows a flow chart of a printing method according to an embodiment of the disclosure. As shown in FIG. 1, the printing method comprises:

step 1001, forming an organic material layer on a non-printing region of a substrate, wherein the burning point of the organic material layer is lower than the pre-curing temperature of glass glue;

step 1002, performing printing processing on the substrate so as to form the glass glue on a printing region of the substrate; and

step 1003, performing a burning processing of the organic material layer so as to separate the organic material layer from the substrate.

By forming the organic material layer on the substrate, the printing method according to the embodiment of the disclosure as shown in FIG. 1 causes the organic material layer to fully block the non-printing region when glass glue is printed, and removes or takes away excess glass glue which can result in the printing offset and burrs by burning processing, thereby effectively avoiding the occurrence of the printing offset and burrs so as to greatly reduce the rate of defective goods.

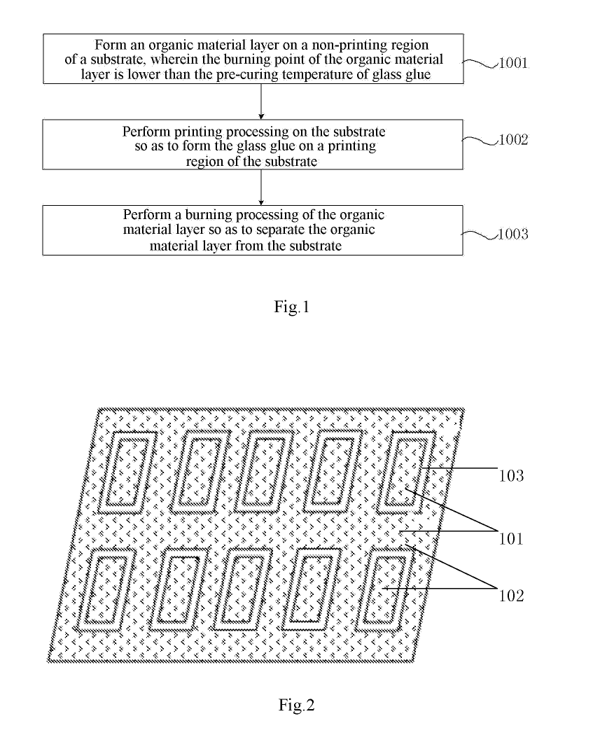

In the following, the individual steps of the printing method according to the embodiment of the disclosure as shown in FIG. 1 will be specifically illustrated in conjunction with FIGS. 2-6, respectively.

FIG. 2 shows a schematic diagram of the step 1001 of forming an organic material layer 102 on a non-printing region 101 of a substrate of the printing method as shown in FIG. 1. As shown in FIG. 2, the substrate comprises a printing region 103 and the non-printing region 102. According to the step 1001 of the printing method according to the embodiment of the disclosure as shown in FIG. 1, as shown in FIG. 2, the organic material layer 101 is formed on the non-printing region 102 of the substrate, that is, the organic material layer 101 fully blocks the non-printing region 102 of the substrate, and at the same time, causes the printing region 103 of the substrate to be exposed.

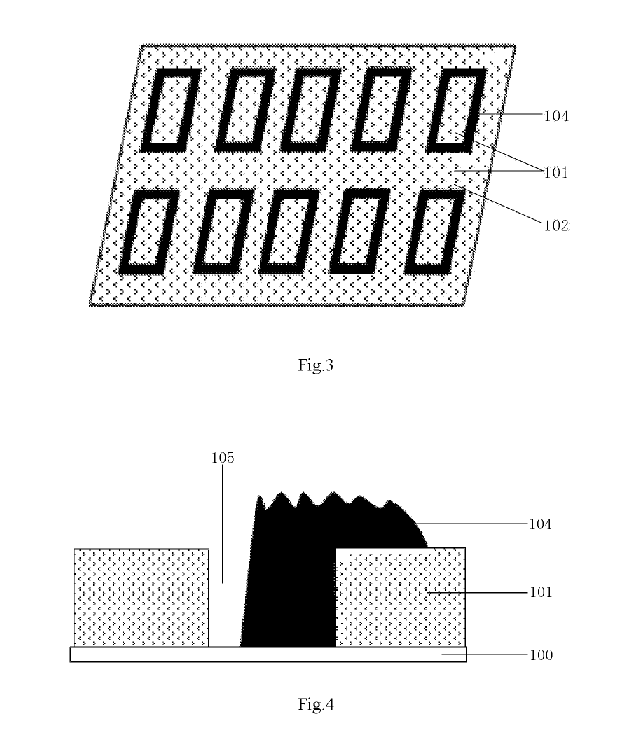

FIG. 3 shows a schematic diagram of the step 1002 of performing printing processing on the substrate so as to form the glass glue 104 on a printing region 103 of the printing method as shown in FIG. 1. As shown in FIG. 3, by the printing processing of the substrate, the printing region 103 is fully covered by the glass glue 104.

Since before the printing process, as shown in FIG. 2 and FIG. 3, the organic material layer 101 fully blocks the non-printing region 102 of the substrate, the glass glue 104 deviating from the printing region 103 will be adhered to the organic material layer 101, thereby effectively eliminating the generation of the printing offset and burrs.

Further, the organic material layer 101 as shown in FIG. 2 and FIG. 3 may have the following characteristics. First, the organic material layer 101 formed on the non-printing region 102 and the glass glue 104 formed on the printing region 103 have the same thickness. As such, it can be ensured that the printing height of the glass glue 104 reaches the expected height required by the process, and meanwhile, it is avoided that the glass glue 104 overflows to the non-printing region 102 in the procedure of printing. Second, the constituent material of the organic material layer 101 will not react chemically with the glass glue 104. In particular, when the temperature is at and below the pre-curing temperature, the metal element contained in the glass glue 104 in contact with the organic material layer 101 will not have an oxidation reaction with the organic material in the organic material layer 101. Therefore, it effectively avoids damage of the oxidation reaction to the glass glue 104 for printing and thus to the printing process.

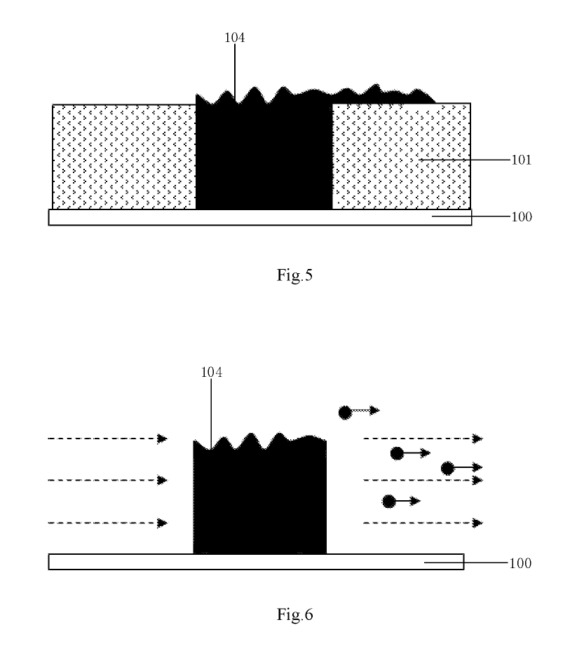

In addition, as described at the step 1001 of the printing method shown in FIG. 1, the burning point of the constituent material of the organic material layer 101 is lower than the pre-curing temperature of the glass glue 104, so that when the pre-curing processing is performed on the glass glue 104 at a subsequent step, it is effectively ensured that the burning processing may certainly be performed on the organic material layer 101, and consequently, the excess glass glue 104 that results in the printing offset and burrs is eventually taken away or removed by the burning processing, thereby effectively avoiding the occurrence of the printing offset and burrs and thus greatly reducing the rate of defective goods. For the pre-curing processing of the glass glue 104 and the burning processing of the organic material layer 101, a specific description will be given in the following with reference to FIG. 6. In general, the pre-curing temperature of the glass glue 104 can range from 100° C. to 120° C., while the range of the burning point of the organic material layer 101 may be 85° C. to 115° C. . For example, when the pre-curing temperature of the glass glue 104 is 100° C., the range of the burning point of the organic material layer 101 may be 85° C. to 95° C.; when the pre-curing temperature of the glass glue 104 is 120° C., the range of the burning point of the organic material layer 101 may be 105° C. to 115° C.; when the pre-curing temperature of the glass glue 104 is 110° C., the range of the burning point of the organic material layer 101 may be 95° C. to 105° C. Specially, the pre-curing temperature of the glass glue 104 may be 110° C., and at this point, the burning point of the organic material layer 101 may be 100° C.

FIG. 4 shows a sectional view of printing offset occurring in the procedure of printing processing of the step 1002 of the printing method as shown in FIG. 1. As shown in FIG. 4, in the procedure of printing processing at the step 1002 of the printing method of the disclosure, the glass glue 104 formed in a groove 105 of the printing region deviates toward the right, that is to say, the left of the groove 105 is not fully filled with the glass glue 104, while on the right the glass glue 104 goes beyond the printing region and its height exceeds the organic material layer 101 (and also exceeds a predetermined thickness of the glass glue 104).

Since the organic material layer 101 fully blocks the non-printing region 103 of the substrate 100 and the glass glue 104 has a certain viscosity, when the printing offset occurs, the glass glue 104 in the groove 105 of the printing region has a certain pulling force for the glass glue 104 deviating from the printing region and adhered to the top of the organic layer 101, such that the glass glue 104 to which the printing offset occurs levels into the groove 105. FIG. 5 shows a sectional view of the glass glue 104 to which the printing offset occurs as shown in FIG. 4 after leveling. As shown in FIG. 5, the glass glue 104 after leveling fully fills the groove 105 of the printing region of the substrate 100, and only part of the glass glue 104 with a very thin thickness is left on the organic material layer 101, which thus may substantially decrease the excess glass glue 104 which can result in the printing offset and burrs, thereby effectively avoiding the occurrence of the printing offset and burrs and greatly reducing the rate of defective goods.

At the step 1003 of the printing method as shown in FIG. 1, the burning processing of the organic material layer may be done by the following operation: placing the substrate on which the glass glue 104 has formed by the printing processing into a pre-curing device and performing a pre-curing processing of the glass glue 104. Since as described at the step 1001, the burning point of the organic material layer 101 is lower than the pre-curing temperature of the glass glue 104, the organic material layer 101 starts to burn, and thereby is separate from the substrate 100. FIG. 6 shows a separation diagram of the glass glue 104 with printing offset and the glass glue 104 for which the printing is normal in the procedure of burning processing of the organic material layer in the printing method as shown in FIG. 1. As shown in FIG. 6, before performing the pre-curing processing of the glass glue 104, the substrate 100 may be placed in flowing gas with a fixed flow direction. The arrow direction as shown in FIG. 6 is the fixed flow direction of the flowing gas. In general, the flowing gas may be clean and dry compressed air (CDA). Once the organic material layer starts to burn, the little glass glue 104 adhered to the organic material layer will be driven up and discharged out of the pre-curing device (not shown) together with hot gas, thereby effectively avoiding the occurrence of the printing offset and burrs and thus greatly reducing the rate of defective goods. Of course, besides being performed at the same time as the procedure of the pre-curing processing of the glass glue 104, the procedure of the burning processing of the organic material layer can also be performed alone, as long as the temperature of the process reaches the burning point of the organic material layer and does not exceed the pre-curing temperature of the glass glue 104.

In the description of the disclosure, it needs to be noted that, the orientation or position relationship indicated by the terms “on”, “below”, etc. is an orientation or position relationship based on what is shown in the drawings, it is only for the convenience of describing the disclosure and simplifying the description, but does not indicate or imply that the apparatus or element referred to must have a specific orientation and be constructed and operated in a specific orientation, and therefore cannot be understood as limiting the disclosure. For those of ordinary skills in the art, the specific meaning of the above terms in the disclosure may be understood according to the specific circumstances.

It also needs to be noted that in this context a relational term such as first, second, etc. is only used to distinguish one entity or operation from another entity or operation, and does not necessarily require or imply there is any such an actual relation or order between these entities or operations. Moreover, the term “comprise”, “comprising” or any other conjugation thereof is intended to encompass a non-exclusive inclusion, such that a procedure, method, article, or apparatus comprising a series of elements not only comprises those elements, but also comprises other elements not expressly listed, or further comprises elements inherent to the procedure, method, article, or apparatus. In the absence of more restrictions, an element defined by a phrase “comprises a . . . ” does not exclude the presence of additional identical elements in a procedure, method, article, or apparatus comprising the element.

It may be appreciated that, the above embodiments are exemplary embodiments employed for the purpose of illustrating the principles of the disclosure, and however, the disclosure is not limited thereto. For those of ordinary skills in the art, various variations and improvements may be made without departing from the spirit and substance of the disclosure, and these variations and improvements are also construed as falling within the protection scope of the disclosure.

1. A printing method, comprising:
forming an organic material layer on a non-printing region of a substrate, a burning point of the organic material layer being lower than a pre-curing temperature of glass glue;
performing printing processing on the substrate so as to form the glass glue on a printing region of the substrate; and
performing a burning processing of the organic material layer so as to separate the organic material layer from the substrate.

2. The printing method according to claim 1, wherein the step of performing a burning processing of the organic material layer comprises performing a pre-curing processing of the glass glue.

3. The printing method according to claim 2, further comprising:
placing the substrate in flowing gas with a fixed flow direction before performing the pre-curing processing of the glass glue.

4. The printing method according to claim 1, wherein a range of the pre-curing temperature of the glass glue is 100° C. to 120° C., and a range of the burning point of the organic material layer is 85° C. to 115° C.

5. The printing method according to claim 4, wherein the pre-curing temperature of the glass glue is 100° C., and the range of the burning point of the organic material layer is 85° C. to 95° C.

6. The printing method according to claim 4, wherein the pre-curing temperature of the glass glue is 120° C., and the range of the burning point of the organic material layer is 105° C. to 115° C.

7. The printing method according to claim 4, wherein the pre-curing temperature of the glass glue is 110° C., and the range of the burning point of the organic material layer is 95° C. to 105° C.

8. The printing method according to claim 4, wherein the pre-curing temperature of the glass glue is 110° C., and the burning point of the organic material layer is 100° C.

9. The printing method according to claim 1, further comprising:
placing the substrate in flowing gas with a fixed flow direction before the step of performing the burning processing of the organic material layer.

10. The printing method according to claim 9, wherein the flowing gas is compressed air.

11. The printing method according to claim 1, wherein the organic material layer and the glass glue have the same thickness.

12. The printing method according to claim 1, wherein the organic material layer is made of a material which cannot react chemically with the glass glue.
